(19) United States
(12) Patent Application Publication
(10) Pub. No.: US 2026/0021765 A1
(43) Pub. Date: Jan. 22, 2026

(54) VIRTUAL PROJECTION METHOD AND DISPLAY SYSTEM FOR DISPLAYING IMAGE OF OBSCURED OBJECT

(71) Applicant: National Taipei University of Technology, Taipei City (TW)

(72) Inventor: CHI-HAO LUNG, New Taipei City (TW)

(21) Appl. No.: 19/086,140

(22) Filed: Mar. 21, 2025

(30) Foreign Application Priority Data
Jul. 22, 2024 (TW) 113127257

(51) Int. Cl. B60R 1/22; G06F 3/01; G06T 7/246; G06T 7/73; G06V 20/40; G06V 20/58; G06V 40/10; H04N 7/18

(52) U.S. Cl. CPC B60R 1/22; G06F 3/013; G06T 7/246; G06T 7/73; G06V 20/41; G06V 20/58; G06V 40/10; H04N 7/181; B60R 2300/8093; G06T 2207/10016; G06T 2207/30196; G06T 2207/30261

(57) ABSTRACT

A virtual projection method and a display system for displaying an image of an obscured object. The display system includes a computation circuit, a camera, and a display device. Based on a field of view of a person, the camera captures a motion image outside of a first side of a blocking body. The display device is disposed on a second side of the blocking body for displaying continuous virtual projection images generated from processing the motion image. Each frame of the motion image is calibrated according to a curvature of the blocking body and a size and a shape of a display panel of the display device. Each frame along a planar axis is calibrated into a virtual projection image matching the size, shape, and curvature. The virtual projection image is joined with an unobstructed field of view to form a complete stitched image in real time.

### CROSS-REFERENCE TO RELATED PATENT APPLICATION

This application claims the benefit of priority to Taiwan Patent Application No. 113127257, filed on Jul. 22, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an auxiliary technology for displaying an obscured portion of a line of sight, and more particularly to a virtual projection method and a display system for displaying an image of an obscured object in a scene where a line of sight of the human eye is obscured.

### BACKGROUND OF THE DISCLOSURE

When driving, drivers rely on a field of view of their eyes for noting the surroundings of a vehicle, so as to ensure driving safety. However, a line of sight of the driver can often be obscured by the typical structure of an automobile, thereby causing problems in driving safety.

For example, a front support structure (commonly referred to as the A-pillar) for supporting a vehicle top and strengthening a vehicle body structure is disposed on left and right sides of a driver position in the vehicle. When the line of sight of the driver is directed to the left or the right, the A-pillar becomes a structure that obstructs the line of sight. Since a blind spot in the field of view of the driver often exists when the vehicle turns left or right, driving safety can be negatively affected.

While the A-pillar of the vehicle may affect driving safety, there are other situations in daily life where safety can be compromised due to an obscured line of sight. For example, when the vehicle passes a corner, and a building or an object can obscure the line of sight, the driver of the vehicle may not be able to determine the road condition on the other side of the corner, so that safety concerns caused by the obscured line of sight may occur.

### SUMMARY OF THE DISCLOSURE

In response to the above-referenced technical inadequacies, the present disclosure provides a virtual projection method and a display system for displaying an image of an obscured object. Through an image display technology, the problem of blind spots in a field of view can be solved when a line of sight is obscured by an internal vehicle structure or an external structural body, and a driver or a pedestrian can see objects obscured by a blocking body, thereby effectively addressing safety concerns.

According to one embodiment, the display system includes a computation circuit, a camera, and a display device. The computation circuit is configured to perform the virtual projection method. The camera is disposed on a first side of the blocking body, or is disposed at a position that is located on a windshield within a vehicle and in close proximity to the driver. Based on a field of view of a person, the camera is configured to capture a motion image outside of the first side. The display device is disposed on a second side of the blocking body, and the second side is oriented toward the person, so as to instantly display continuous virtual projection images generated from processing of the motion image. The virtual projection image can be joined with an unobstructed field of view to form a complete stitched image. A procedure of the motion image includes: calibrating each frame of the motion image according to a curvature of a surface of the blocking body and a size and a shape of a display panel of the display device, such that each frame along a planar axis is calibrated into a virtual projection image that matches the size, the shape, and the curvature.

In one configuration, the blocking body is a front support structure (commonly referred to as the A-pillar) or a rear support structure (commonly referred to as the C-pillar) of the vehicle. The camera is disposed at a position that is located on the first side outside of the support structure or is located on the windshield within the vehicle and in close proximity to the driver for capturing an external image according to the line of sight of the driver that is directed along the support structure. Furthermore, the display device is disposed at a position that is located on the second side of the support structure within the vehicle and is oriented toward a viewing angle range of the eyes of the driver. In another configuration, the blocking body is a structural body, and the camera is disposed at a position that is located on a same side of a user relative to the structural body and at a lateral offset from the user for capturing an image outside of the first side of the structural body according to a line of sight of the user. In addition, the display device is disposed at a position that is located on the second side of the structural body and is oriented toward the user.

Furthermore, the display device can be a flexible display device, and is adhered to the second side of the blocking body.

Furthermore, the display system operates an image identification model to identify one or more objects in the motion image, and to label each of the identified objects when the display device displays the continuous virtual projection images.

Furthermore, the display system also operates a visual point tracking technique to identify a visual point position of the person (i.e., a viewing position of the human eye). During calibration of each frame of the motion image, the virtual projection image is adjusted according to the visual point position of the person, so as to obtain a matching see-through view of their sight.

In the virtual projection method, each frame of the motion image is calibrated in the following manner. Firstly, multiple frame images of the motion image that are formed by imaging along the planar axis are obtained, and the motion image is converted according to the size and the shape of the display panel that is adhered to the second side of the blocking body and according to the curvature. The converted motion image is further projected onto a region of the display panel to be used for the virtual projection image based on the size and the shape, and then each of the frame images formed by imaging along the planar axis is converted into the virtual projection image having the curvature. Accordingly, the calibrated motion image can be provided for the person to see the image of the object obscured by the blocking body.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of a display system for displaying an image of an obscured object according to one embodiment of the present disclosure;

FIG. 2 is a schematic view showing installation of the display system for displaying the image of the obscured object in a vehicle according to one embodiment of the present disclosure;

FIG. 3 is a schematic view showing an outdoor scene in which the display system for displaying the image of the obscured object is installed according to one embodiment of the present disclosure;

FIG. 4 is a schematic diagram of circuit components of the display system for displaying the image of the obscured object according to one embodiment of the present disclosure;

FIG. 5 is a flowchart of a virtual projection method for displaying the image of the obscured object according to one embodiment of the present disclosure; and

FIG. 6A, FIG. 6B, and FIG. 6C are each a schematic view showing calibration of a virtual projection image according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure provides a virtual projection method and a display system for displaying an image of an obscured object. When a line of sight of a person is obscured by a blocking body in a specific scene, the technical purpose of the present disclosure is to allow the person to see the obscured object on another side via the display system and to obtain a complete stitched image formed by joining of an unobstructed field of view. For example, a line of sight of a driver is obscured by a front support structure (commonly referred to as the A-pillar) or a rear support structure (commonly referred to as the C-pillar) of a vehicle, and the obscured object on another side can be displayed via the display system, thereby generating a see-through effect for the front support structure or the rear support structure. In another example, when the vehicle travels on the road or a pedestrian walks on the road (especially at a corner), the line of sight can be obscured not only by the support structure of the vehicle, but also by an external structural body that acts as the blocking body. Hence, through installation of the display system on the blocking body, the driver or the pedestrian is allowed to see the obscured object behind the blocking body, thereby effectively improving driving safety and safety of the pedestrians on the road.

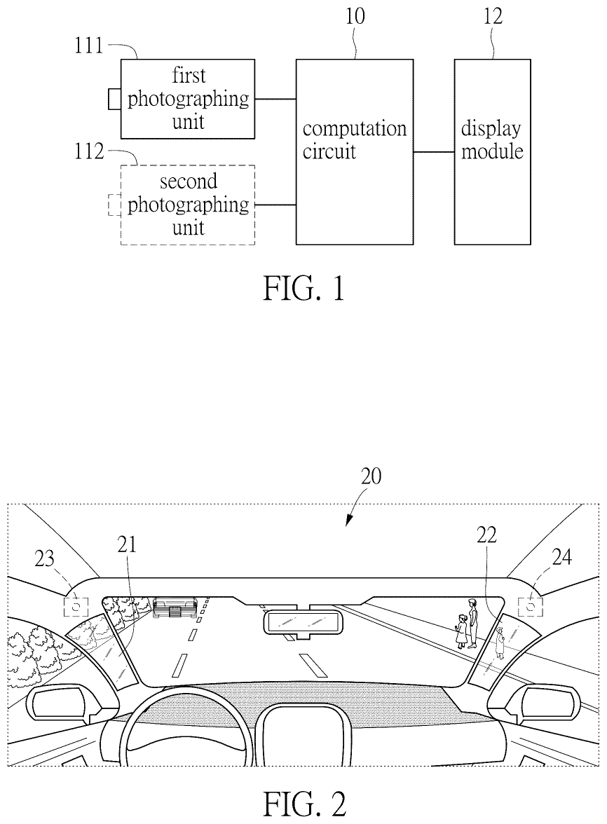

FIG. 1 is a block diagram of the display system for displaying the image of the obscured object according to one embodiment of the present disclosure. The main circuit of the display system includes a computation circuit 10, a photographing module (e.g., a first photographing unit 111 and a second photographing unit 112), and a display module 12.

According to one embodiment, the computation circuit 10, the photographing module, and the display module 12 can be independent devices that operate separately and are connected to each other via wires or specific communication technologies, such as a computation device, a camera, and a display device. Specifically, in the display system, the quantity of the photographing module or the camera and the quantity of the display module 12 or the display device are not limited to the example above. In another configuration, according to practical requirements, the display system can be expanded to include more than one camera and more than one display device. The multiple cameras and the multiple display devices can be connected in series with each other, so as to respectively capture and display the object obscured by the blocking body. After integration, a complete image of the obscured object can be obtained to achieve a patching effect for the field of view.

In another embodiment, the display system can be implemented as a device having photographing and displaying functions, such as a computer apparatus that operates independently. The computation circuit 10 is configured to perform the virtual projection method, so as to convert a motion image captured by the photographing module into continuous virtual projection images that are instantly displayed on the display module 12. In particular, a display panel of the display module 12 is designed to be applicable for specific scenes, such as on the support structure of the vehicle or on a specific structural body on the road. As such, the conversion is to convert a captured planar image according to the design of the display panel, so as to obtain a virtual projection image that fits the scene of application. In addition, the virtual projection image can be joined with the unobstructed field of view to form the complete stitched image.

In yet another embodiment, the photographing module and the display module 12 are two separate devices, and the computation circuit 10 that performs the conversion of the virtual projection image can be disposed in the photographing module or the display module 12.

The display system can be designed to operate two or more cameras and display devices, and the cameras can be the first photographing unit 111 and the second photographing unit 112 as shown in the drawing. The scene of application can be, for example, an interior of the vehicle. Two of the front support structures (the A-pillars) may obscure the forward-directed line of sight of the driver, and two of the rear support structures (the C-pillars) may obscure the backward-directed line of sight of the driver. Hence, the corresponding display system is configured to include more than one photographing unit and more than one display device. In another configuration, the second photographing unit 112 can be applied to implement tracking of the human eye (visual point tracking).

Reference is made to FIG. 2, which is a schematic view showing installation of the display system for displaying the image of the obscured object in the vehicle according to one embodiment of the present disclosure. In this example, the scene of application is a vehicle 20. The blocking body of the vehicle 20 is the support structure of the vehicle, which include the front support structures (the A-pillars) and the rear support structures (the C-pillars) mentioned above. The camera (which acts as the photographing module) is disposed at a position that is located on a first side (i.e. an outward-oriented side) outside of the support structure or is located on a windshield within the vehicle and in close proximity to the driver for capturing an external image according to the line of sight of the driver that is directed along the support structure. The position can be, for example, an outer structure of the A-pillar or the C-pillar. This example includes a first camera 23 that is disposed on the A-pillar at the left side of the vehicle and captures an external scene, and a second camera 24 that is disposed on the A-pillar at the right side of the vehicle.

The display device (e.g., a flexible display device) can act as a display module. The display device is disposed at a position that is located on a second side (i.e., a side that is oriented toward the interior of the vehicle) of the support structure within the vehicle and is oriented toward a viewing angle range of the eyes of the driver. This example includes a first display device 21 that is disposed on the A-pillar at the left side of the vehicle, and a second display device 22 that is disposed on the A-pillar at the right side of the vehicle.

Based on the above, the technical purpose of the display system is to solve the problem of blind spots in a field of view by displaying an image outside of the A-pillar that obscures the line of sight of the driver. In practice, the first display device 21 and the second display device 22 display the object that is obscured to the line of sight of the driver. By achieving virtual projection, a see-through visual effect can be generated for the A-pillars at the left and right sides, such that the field of view of the driver can be complete.

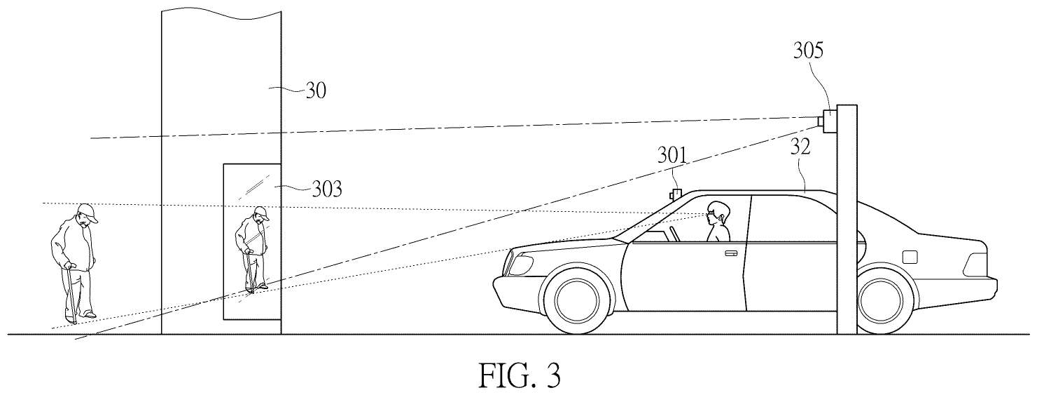

FIG. 3 is a schematic view showing an outdoor scene in which the display system for displaying the image of the obscured object is installed according to one embodiment of the present disclosure. In this example, the blocking body is a structural body 30, and a vehicle 32 travels on the road. The vehicle 32 is designed to include a vehicle camera 301 as described in the example mentioned above, so as to solve the problem of blind spots in the field of view as shown in FIG. 2. When the vehicle 32 is in motion, the structural body 30 in the front or at a left or right corner may obscure an object behind the structural body 30. In such a situation, the display system of the present disclosure can be disposed on the structural body 30 (e.g., pillars).

The display system of one embodiment is provided to capture a motion image outside of a first side of the blocking body based on a field of view of the person. As shown in FIG. 3, a camera 305 is disposed at a position that is located on a same side of a user relative to the structural body 30 and at a lateral offset from the user for capturing an image outside of a first side of the structural body 30 according to a line of sight of the user (the pedestrian on the road or the driver of the vehicle). In the drawing, the camera 305 is disposed on a side of the vehicle 32 (i.e., on the same side of the user). At this position, the camera 305 can capture an image that matches a direction of the line of sight of the driver in the vehicle 32 (i.e., the image outside of the first side of the structural body 30). A display device 303 of the display system is disposed on a second side of the structural body 30, which is opposite to the first side and is oriented toward the user.

The display device 303 that is oriented toward the user displays an image that is not visible to the user and can only be captured by the camera 305, such as to allow the user to see the image behind the structural body 30 via the display device 303. In this way, a see-through effect can be generated for the structural body 30.

The structural body 30 that obscures the line of sight on the road can be, for example, man-made constructions (such as the pillars or buildings) at the corner, trees, or other natural objects. The display device of the display system can be a flexible panel that is adhered to the structural body 30 and that obscures the line of sight. A shape and a size of the display device can be designed according to the scene of application.

In yet another example, the display system can be implemented in a real-time monitoring screen disposed on a bridge column under an overpass. The display device can provide a clear field of view, such that the driver of the vehicle can directly check oncoming traffic on an opposite lane when making a turn.

Furthermore, in one of the embodiments, a vision solution in which the contents of the same image space are integrated in a virtual and unobstructed manner can be achieved. According to the degree of complexity under which the line of sight of the person is obscured in a specific scene, the display system of the present disclosure can be expanded into a system that includes more than one camera and more than one display device. The photographing module can be implemented as the multiple cameras, and the display module can be implemented as the multiple display devices.

The multiple cameras correspond to the multiple display devices, and are connected in series with each other via a control device. Accordingly, even if the line of sight of the person is obscured in a complicated manner, images at multiple visual point positions can still be captured by the multiple cameras, and then can be correspondingly displayed on the multiple display devices. The images can be integrated to generate the virtual projection image that is displayed outside of the first side of the blocking body. That is, an effect of preventing the line of sight of the person in a specific scene from being obscured by any blocking body (e.g., an architectural structural body) can be achieved, and the virtual projection image can be joined with the unobstructed field of view to form the complete stitched image.

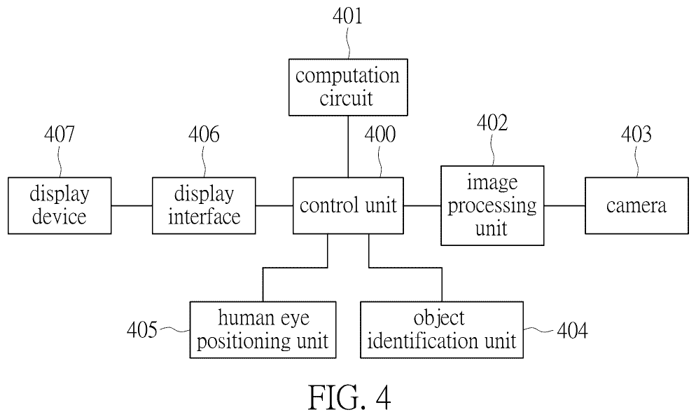

FIG. 4 is a schematic diagram of circuit components of the display system for displaying the image of the obscured object according to one embodiment of the present disclosure.

The display system shown in this example includes a control unit 400 that controls operation of each component. The control unit 400 is electrically connected to other circuits or software components. For example, a computation circuit 401 is configured to perform the virtual projection method through cooperation of software and hardware. An image processing unit 402 is configured to process image data obtained by a camera 403, so as to convert a light signal into an image signal. A display interface 406 is configured to convert the image data processed by the computation circuit 401 into a display signal, and the display signal is displayed via a display device 407.

Specifically, the display system can further include an object identification unit 404. The object identification unit 404 is an image identification model that is obtained by using a machine learning algorithm to train a considerable amount of the image data, and one or more objects (e.g., a person walking on the road, an animal, or a stationary object) in a motion image captured by the camera 403 can be instantly identified in a frame-by-frame manner. In addition, each of the identified objects can be labelled when the display device 407 instantly displays continuous virtual projection images.

According to one embodiment, the display system can further include a human eye positioning unit 405 that is applicable in the vehicle, and another camera is used to capture an image of the interior of the vehicle. Through an image identification technology or the image identification model, the visual point position of the driver can be instantly identified according to a visual point tracking technique. During calibration of each frame of the motion image, the virtual projection image can be adjusted according to the visual point position of the person.

Specifically, the driver of the vehicle may adjust their viewing direction at any time. The human eye positioning unit 405 enables a software procedure operated in the display system to instantly determine the field of view according to the visual point position of the person. Through operation of the control unit 400, the computation circuit 401 performs a computation to modify the virtual projection image displayed on the display device 407. Alternatively, in order for an image of an external object that is obscured by the support structure within the vehicle to be accurately displayed on the display device 407, a capturing angle of the camera 403 can be controlled via the control unit 400.

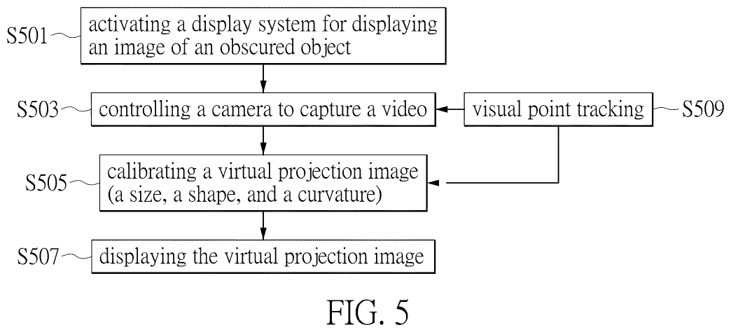

FIG. 5 is a flowchart of the virtual projection method for displaying the image of the obscured object according to one embodiment of the present disclosure.

The process starts by activating the display system (step S501). Operation of each circuit component is controlled by a control unit, which includes controlling the camera to capture a video (step S503) and further activating a human eye positioning unit to track a viewing position of the eyes (i.e., the visual point position) of the driver (step S509). One of the purposes of step S509 is as follows. When the camera is capturing the motion image, a computation circuit can adaptively convert said image captured by the camera based on an area (e.g., a size and a shape) of the line of sight of the human eye that is obscured by the object. Then, the converted motion image is projected onto a region of the display device to be used for a display image based on the size and the shape. As such, the visual point position of the person will affect the image conversion procedure, and the virtual projection image that is instantly displayed on the display device is finally formed. The virtual projection image can be joined with the unobstructed field of view to form the complete stitched image.

Another purpose of the visual point tracking is to aid computation of image conversion of the computation circuit. According to one embodiment, processing the motion image by the computation circuit includes: calibrating each frame of the motion image according to a curvature of a surface of the blocking body (which also affects a curvature of the flexible display device) and a size and a shape of a display panel of the display module. The blocking body is, for example, the support structure of the vehicle and the structural body on the road mentioned in the embodiment above. Furthermore, referring to the result of the visual point tracking, each frame along a planar axis is calibrated into the virtual projection image that matches the size and the shape of the display panel, the field of view of the person, the curvature, etc. (step S505). Finally, the virtual projection image is displayed via the display module (step S507). The virtual projection image can be joined with the unobstructed field of view to form the complete stitched image.

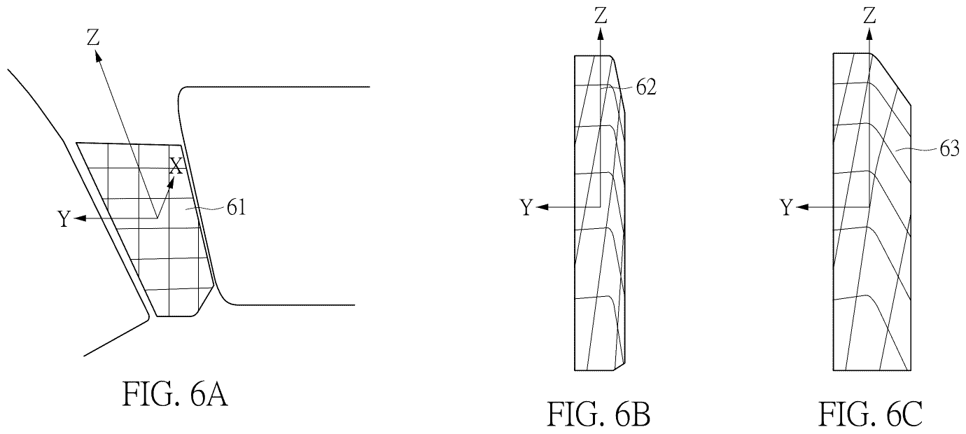

Regarding calibration of each frame of the motion image in the virtual projection method, reference can be made to FIG. 6A to FIG. 6C. FIG. 6A to FIG. 6C are each a schematic view showing calibration of the virtual projection image according to one embodiment of the present disclosure.

Multiple frame images of the motion image that are formed by imaging along the planar axis are obtained. For example, one of the frame images is a vehicle A-pillar arc-shaped surface 61 as shown in FIG. 6A, which shows the image of the obscured object that is taken by the camera according to a direction of the line of sight (i.e., a visual point) of the eyes of the driver that is formed along the A-pillar of the vehicle. The typical A-pillar of the vehicle is designed to be tilted. As such, an X-axis as shown in FIG. 6A has an angle of elevation, which matches an A-pillar viewing angle of the driver. Such an image needs to be converted according to the size and the shape of the display panel that is adhered to an inner side of the blocking body (e.g., the A-pillar of the vehicle) and according to the curvature. The image itself is not necessarily consistent with the display panel of the display device (e.g., an image along a specific axial direction may be deformed or elongated after adjustment), and it is necessary to adjust the content that is eventually displayed to be an image that substantially matches the size and the shape of the display device from a viewing point of the user. Reference can be made to an axial calibration diagram 62 as shown in FIG. 6B.

Referring to XYZ coordinate axes of the vehicle A-pillar arc-shaped surface 61 as shown in FIG. 6A, the axial calibration diagram 62 as shown in

FIG. 6B is a schematic diagram showing a Y-Z plane of the display panel on the A-pillar of the vehicle, and the X-axis is an axis that is perpendicular to the diagram (and is thus not shown in the drawing). That is, in order for the display image to appear realistic to the human eye, each frame image formed by imaging along the planar axis needs to be converted into the virtual projection image having the curvature.

It is worth mentioning that, when synchronized output to the flexible display device having the curvature of the surface on the A-pillar of the vehicle is required, the display system can obtain the visual point position of the driver by the above-mentioned eyeball positioning technology, so as to convert the image into the virtual projection image that matches the visual point position of the driver. FIG. 6C shows an output image 63 of the flattened display panel (the Y-Z plane), and the calibrated motion image is provided for the driver to see the image of the object obscured by the support structure.

### Beneficial Effects of the Embodiments

In conclusion, in the virtual projection method for displaying the image of the obscured object and the display system for performing the virtual projection method provided by the present disclosure, the camera is used to capture the image of the object in the direction of the obscured line of sight. After conversion and calibration, the image is projected onto the display device, such that the user can see the obscured object via the displayed content. In this way, the purpose of virtually projecting the image of the obscured object can be achieved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A display system for displaying an image of an obscured object, comprising:
a computation circuit configured to perform a virtual projection method for displaying the image of the obscured object;
a camera electrically connected to the computation circuit; wherein, based on a field of view of a person, the camera is configured to capture a motion image outside of a first side of a blocking body; and
a display device electrically connected to the computation circuit, wherein the display device is disposed on a second side of the blocking body, and the second side is oriented toward the person, so as to display continuous virtual projection images generated from processing of the motion image by the virtual projection method;
wherein processing the motion image by the virtual projection method includes: calibrating each frame of the motion image according to a curvature of a surface of the blocking body and a size and a shape of a display panel of the display device, such that each frame along a planar axis is calibrated into a virtual projection image that matches the size, the shape, and the curvature.

2. The display system according to claim 1, wherein an image identification model is operated to identify one or more objects in the motion image captured by the camera, and to label each of the identified objects when the display device displays the continuous virtual projection images.

3. The display system according to claim 1, wherein a visual point tracking technique is operated to identify a visual point position of the person;
wherein, during calibration of each frame of the motion image, the virtual projection image is adjusted according to the visual point position of the person.

4. The display system according to claim 1, wherein the blocking body is a support structure of a vehicle, and the camera is disposed at a position that is located on the first side outside of the support structure or is located on a windshield within the vehicle and in close proximity to a driver for capturing an external image according to a line of sight of the driver that is directed along the support structure.

5. The display system according to claim 4, wherein the display device is disposed at a position that is located on the second side of the support structure within the vehicle and is oriented toward a viewing angle range of eyes of the driver.

6. The display system according to claim 5, wherein an image identification model is provided to identify one or more objects in the motion image captured by the camera, and to label each of the identified objects when the display device displays the continuous virtual projection images.

7. The display system according to claim 5, wherein a visual point tracking technique is operated to identify a visual point position of the person; wherein, during calibration of each frame of the motion image, the virtual projection image is adjusted according to the visual point position of the person.

8. The display system according to claim 1, wherein the blocking body is a structural body, and the camera is disposed at a position that is located on a same side of a user relative to the structural body and at a lateral offset from the user for capturing an image outside of the first side of the structural body according to a line of sight of the user.

9. The display system according to claim 8, wherein the display device is disposed at a position that is located on the second side of the structural body and is oriented toward the user.

10. The display system according to claim 1, wherein a quantity of the camera and a quantity of the display device are more than one, the multiple cameras are configured to capture images at multiple visual point positions, and the images are correspondingly displayed on the multiple display devices;
wherein the images are integrated to generate the virtual projection image that is displayed outside of the first side of the blocking body.

11. The display system according to claim 10, wherein an image identification model is operated to identify one or more objects in the motion image captured by the camera, and to label each of the identified objects when the display device displays the continuous virtual projection images.

12. The display system according to claim 10, wherein a visual point tracking technique is operated to identify the visual point position of the person;
wherein, during calibration of each frame of the motion image, the virtual projection image is adjusted according to the visual point position of the person.

13. A virtual projection method for displaying an image of an obscured object, which is operated in a display system, the virtual projection method comprising:
capturing, based on a field of view of a person, a motion image at a first side of a blocking body by a camera of the display system;
calibrating each frame of the motion image according to a curvature of a surface of the blocking body and a size and a shape of a display panel of a display device of the display system, such that each frame along a planar axis is calibrated into a virtual projection image that matches the size, the shape, and the curvature; and
displaying, by the display device that is disposed on a second side of the blocking body, continuous virtual projection images generated from processing of the motion image.

14. The virtual projection method according to claim 13, wherein calibrating each frame of the motion image includes:
obtaining multiple frame images of the motion image that are formed by imaging along the planar axis; and
converting, according to the size and the shape of the display panel that is adhered to the second side of the blocking body and according to the curvature, each of the frame images to match the size and the shape of the display panel to be used for the virtual projection image, and then converting each of the frame images formed by imaging along the planar axis into the virtual projection image having the curvature;
wherein the calibrated motion image enables the person to view the image of the object obscured by the blocking body.

15. The virtual projection method according to claim 13, wherein the display system operates an image identification model to identify one or more objects in the motion image captured by the camera, and to label each of the identified objects when the display device displays the continuous virtual projection images.

16. The virtual projection method according to claim 13, wherein the display system operates a visual point tracking technique to identify a visual point position of the person; wherein, during calibration of each frame of the motion image, the virtual projection image is adjusted according to the visual point position of the person.

17. The virtual projection method according to claim 13, wherein the blocking body is a support structure of a vehicle, and the camera is disposed at a position that is located on the first side outside of the support structure or is located on a windshield within the vehicle and in close proximity to a driver for capturing an external image according to a line of sight of the driver that is directed along the support structure.

18. The virtual projection method according to claim 17, wherein the display device is disposed at a position that is located on the second side of the support structure within the vehicle and is oriented toward a viewing angle range of eyes of the driver.

19. The virtual projection method according to claim 13, wherein the blocking body is a structural body, and the camera is disposed at a position that is located on a same side of a user relative to the structural body and at a lateral offset from the user for capturing an image outside of the first side of the structural body according to a line of sight of the user; wherein the display device is disposed at a position that is located on the second side of the structural body and is oriented toward the user.

20. The virtual projection method according to claim 13, wherein a quantity of the camera and a quantity of the display device are more than one in the display system, the multiple cameras are configured to capture images at multiple visual point positions, and the images are correspondingly displayed on the multiple display devices; wherein the images are integrated to generate the virtual projection image that is displayed outside of the first side of the blocking body.
